(19) United States
(12) Patent Application Publication
(10) Pub. No.: US 2014/0238931 A1
(43) Pub. Date: Aug. 28, 2014

(54) Process for Treating Municiple Wastewater Employing Two Sequencing Biofilm Batch Reactors

(71) Applicant: VEOLIA WATER SOLUTIONS & TECHNOLOGIES SUPPORT, Saint-Maurice (FR)

(72) Inventors: Richard D. DiMassimo, Raleigh, NC (US); Hong W. Zhao, Raleigh, NC (US); Glenn Thesing, Pittsboro, NC (US); Romain Lemaire, Paris (FR); Magnus Christensson, Lund (SE)

(73) Assignee: VEOLIA WATER SOLUTIONS & TECHNOLOGIES SUPPORT, Saint-Maurice (FR)

(21) Appl. No.: 13/777,448

(22) Filed: Feb. 26, 2013

(51) Int. Cl. C02F 3/28

(52) U.S. Cl. CPC C02F 3/286
USPC 210/604

(57) ABSTRACT

A method is provided for removing BOD and ammonium from wastewater in a mainstream process that includes deammonification. Wastewater including BOD and ammonium is directed to a first sequence batch reactor (SBBR). The wastewater is treated in the first SBBR and in the process nitrite is accumulated such that the wastewater includes a nitrite-to-ammonium stoichiometric ratio that enables anammox bacteria to effectively remove ammonium and nitrite from the wastewater. Thereafter the wastewater is directed the wastewater from the first SBBR to a second SBBR. The second SBBR is operated under anoxic conditions and employs anammox bacteria to remove ammonium and nitrite from the wastewater. In certain embodiments, a pre-denitrification step or process is employed in the first SBBR to remove BOD. In addition, in certain embodiments, the second SBBR includes an oxic phase for converting some ammonium to nitrite and, in some cases, an external carbon source is added to the wastewater under anoxic conditions to reduce the concentration of the nitrate in the wastewater.

### FIELD OF THE INVENTION

The present invention relates to a system and process for removing ammonium from a wastewater stream, and more particularly to a deammonification process that entails the use of aerobic ammonium oxidizing bacteria (AOB) and anaerobic ammonium oxidizing (anammox) bacteria.

### BACKGROUND OF THE INVENTION

Typically, wastewater influent includes ammonium nitrogen, NH₄—N. Conventionally, to remove ammonium nitrogen, a two step process is called for, nitrification and denitrification. In this conventional approach to removing ammonium nitrogen, the process entails a first step which is referred to as a nitrification step and which entails converting the ammonium nitrogen to nitrate and a very small amount of nitrite, both commonly referred to as NO_{X}. Many conventional activated sludge wastewater treatment processes accomplish nitrification in an aerobic treatment zone. In the aerobic treatment zone, the wastewater containing the ammonium nitrogen is subjected to aeration and this gives rise to a microorganism culture that effectively converts the ammonium nitrogen to NO_{X}. Once the ammonium nitrogen has been converted to NO_{X}, then the NO_{X}-containing wastewater is typically transferred to an anoxic zone for the purpose of denitrification. In the denitrification treatment zone, the NO_{X}-containing wastewater is held in a basin where there is no supplied air and this is conventionally referred to as an anoxic treatment zone. Here a different culture of microorganisms operate to use the NO_{X} as an oxidation agent and thereby reduces the NO_{X} to free nitrogen which escapes to the atmosphere. For a more detailed understanding and appreciation of conventional biological nitrification and denitrification one is referred to the disclosures found in U.S. Pat. Nos. 3,964,998; 4,056,465; 5,650,069; 5,137,636; and 4,874,519.

Conventional nitrification and denitrification processes have a number of drawbacks. First, conventional nitrification and denitrification processes require substantial energy in the form of oxygen generation that is required during the nitrification phase. Further, conventional nitrification and denitrification require a substantial supply of external carbon source.

In recent years it has been discovered that the concentration of ammonium in certain waste stream can be reduced by utilizing different bacteria from those normally associated with conventional nitrification-denitrification. In this case, a typical process combines aerobic nitritation and anoxic ammonium oxidation (anammox). In the nitritation step, aerobic ammonium oxidizing bacteria oxidize a substantial portion of the ammonium in the waste stream to nitrite (NO₂⁻). Then in the second step, the anammox bacteria or biomass converts the remaining ammonium and the nitrite to nitrogen gas (N₂) and in many cases a small amount of nitrate (NO₃⁻). One particular application of this process is a sidestream process where the waste stream includes a relatively high concentration of ammonium, a relatively low concentration of carbon and a relatively high temperature. The principal drawback to the sidestream processes is that they only address the ammonium concentration in the sidestream and not an associated mainstream. Mainstream in a wastewater treatment plant typically refers to the forward wastewater treatment process where the waste streams include a relatively low ammonia, a relatively high carbon and a relatively low temperature.

There have been attempts at implementing the anammox process in mainstreams to reduce the nitrogen concentration therein. But again, these mainstream applications have focused on wastewater treatment plants that have primary clarifiers and anaerobic digesters. These processes typically include a separate BOD removal stage to remove BOD only from the mainstream and this increases the sludge production to the anaerobic digesters. Following the BOD stage, the mainstream treatment processes typically include nitritation and the anammox process. Since the mainstreams of these processes are not generally conducive to efficient anammox processes, the systems and processes employed have generally relied on a bio-augmentation step where anammox bacteria is transferred from the sidestream to the mainstream. In the end, these mainstream processes that have attempted to employ the anammox process have generally been restricted for a plant with anaerobic digesters and with sidestream anammox applications.

### SUMMARY OF INVENTION

A mainstream wastewater treatment process is disclosed that utilizes anammox bacteria to reduce the nitrogen concentration of the wastewater. The process includes a pretreatment step that aims to condition the wastewater in the mainstream such that it is suitable for subsequent anammox treatment.

In another embodiment of the present invention, the process entails a mainstream process that converts a substantial portion of ammonium in the wastewater to nitrite such that the wastewater includes both ammonium and nitrite. Thereafter, the wastewater including the ammonium and nitrite is subjected to treatment by anammox bacteria which converts the ammonium and nitrite to nitrogen gas.

In yet another embodiment of the present invention, the process entails at least two stages with each stage including a sequence batch biofilm reactor (SBBR) having biomass supported on carriers. In the first stage, the process entails accumulating nitrite by converting a substantial portion of the ammonium in the wastewater to nitrite. In a second stage, conditions are provided or maintained that favor the growth of anammox bacteria on the carriers. The anammox bacteria carry out an anammox process which converts the nitrite and ammonium to nitrogen gas. Thus the process is a main stream process that effectively reduces the ammonium concentration in the wastewater flowing through the mainstream.

In another embodiment of the present invention, it is recognized that by controlling the conversion of ammonium to nitrite that a particular nitrite-to-ammonium stoichiometric ratio range can be achieved and this stoichiometric ratio range is effective to provide a wastewater stream that is conducive to being efficiently treated by anammox bacteria such that the ammonium concentration in the wastewater can be reduced to relatively low levels.

In another embodiment, two SBBRs and a deammonification process is employed to remove ammonium from a wastewater stream having a relatively low carbon-to-nitrogen ratio. Deammonification, however, is not totally relied upon to remove ammonium to relatively low levels. Instead, a pre-denitrification process to remove BOD is integrated into the deammonification process (partial nitritation and anammox process) and is utilized in the first stage SBBR. Additionally in some cases, the anammox process carried out in the second stage SBBR can be supplemented by converting additional ammonium to nitrite under oxic conditions or adding external carbon under anoxic conditions to reduce the concentration of nitrate. Other objects and advantages of the present invention will become apparent and obvious from a study of the following description and the accompanying drawings which are merely illustrative of such invention.

### DESCRIPTION OF THE DRAWINGS

FIG. 1 is a schematic illustration showing a two stage sequence batch biofilm reactor (SBBR) system operated in an integrated fixed film activated sludge (IFAS) mode.

FIG. 1A is a sequence diagram showing a typical sequence for the first SBBR shown in FIG. 1.

FIG. 1B is a sequence diagram showing a typical sequence for the second SBBR shown in FIG. 1.

FIG. 2 is a schematic illustration of a two stage SBBR operated in a moving bed biofilm reactor (MBBR) mode to remove BOD and ammonium from a wastewater stream.

FIG. 2A is a sequence illustration showing a typical sequence for the first SBBR shown in FIG. 2.

FIG. 2B is a sequence diagram showing a typical sequence for the second SBBR shown in FIG. 2.

FIG. 3 is a schematic illustration of a hybrid SBBR process where the first SBBR is operated in an IFAS mode and the second SBBR is operated in an MBBR mode.

FIG. 4 is a schematic diagram showing another hybrid SBBR process where the first SBBR is operated in an MBBR mode and the second SBBR is operated in an IFAS mode.

### DETAILED DESCRIPTION OF THE INVENTION

The system and process described herein entails a two stage sequence batch biofilm (SBBR) reactor for removing BOD and ammonium. The first SBBR reactor receives wastewater, typically municipal wastewater, and functions to pretreat the wastewater such that when it is transferred to the second SBBR reactor it is conditioned such that anaerobic ammonium oxidation (anammox) bacteria is effective to remove ammonium and nitrite from the wastewater. There are two basic processes involved. In the first SBBR reactor, the aim is to conduct partial nitritation. This process entails utilizing ammonium oxidizing bacteria (AOB) in the first SBBR to perform nitritation which converts a substantial portion of the ammonium to nitrite. Once nitritation has been performed in the first SBBR, the wastewaters transfer to the second SBBR where a different species of bacteria is utilized to oxidize the ammonium and nitrite. The second species of bacteria utilized in the second SBBR reactor is anammox bacteria. Anammox bacteria present in the second SBBR is effective to convert the ammonium and nitrite to elemental nitrogen. The process of nitritation coupled with reducing the concentration of ammonium and nitrite with anammox bacteria is referred to as deammonification.

Performing a mainstream deammonification process is challenging because for the anammox process to be effective, it is desirable for the nitrite-ammonium stoichiometric ratio be in the range of about 1.1 to 1.5. Ideally, the ratio should be about 1.3. For many wastewaters, simply employing conventional nitritation will not result in an ideal or desirable nitrite-ammonium ratio. This means that some additional processes may be required in the second SBBR reactor so that the wastewater reaching the second SBBR will have a nitrite-ammonium ratio within the target range or close to the target range. Similarly, in many situations, the anammox process may not reduce ammonium and nitrite levels down to acceptable levels. Thus, even in the second SBBR reactor, some fine tuning, beyond the anammox process, may be appropriate to reduce the concentrations of ammonium and nitrite to acceptable levels. For example, if the nitrite concentration is too low, oxic conditions can be employed in the second stage SBBR to convert additional ammonium to nitrite. Also, if the nitrite concentration in the second SBBR is too high, then external carbon can be added under anoxic conditions to reduce the concentration of nitrite (which will also reduce the concentration of nitrate) in the wastewater.

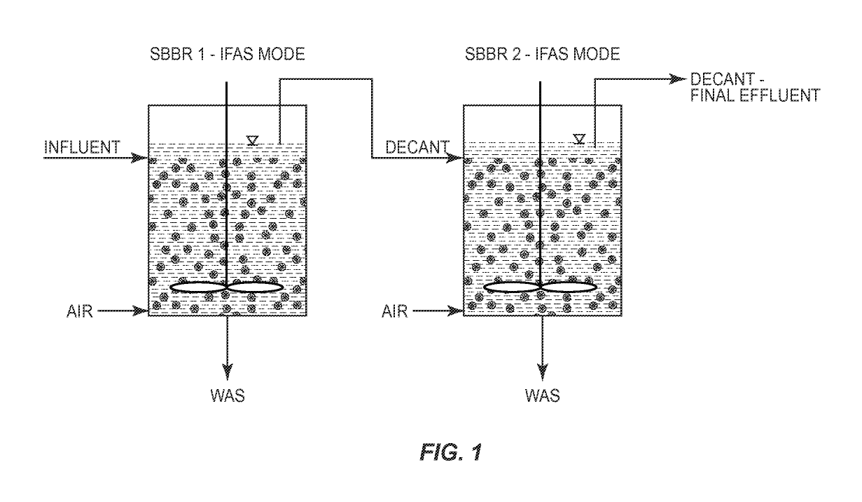

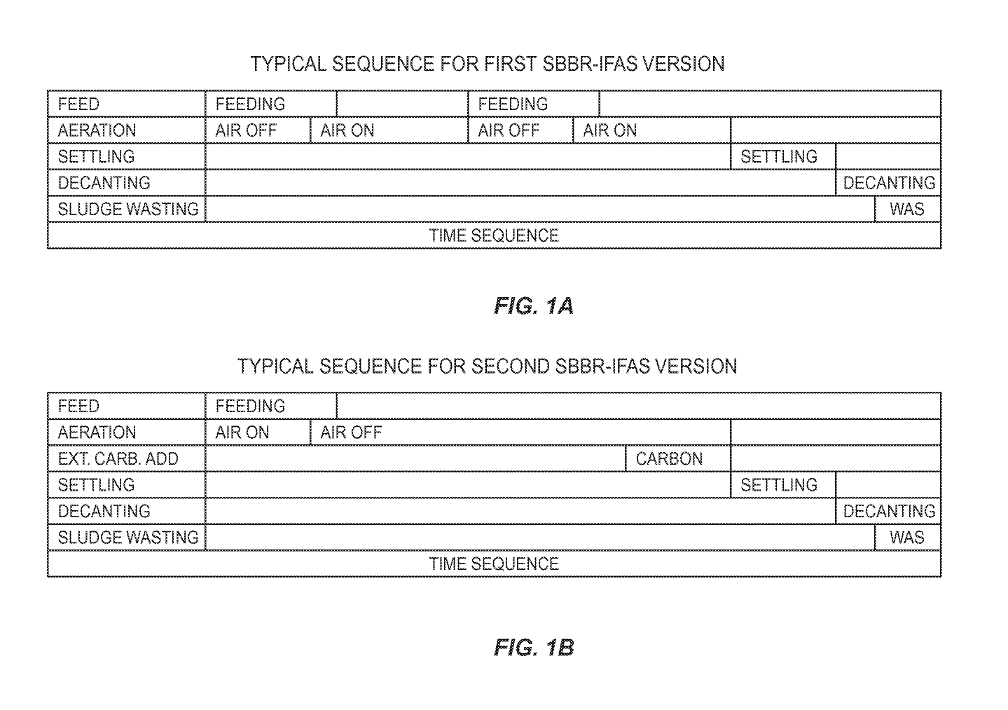

In order to improve the efficiency of a mainstream deammonification process that relies on ammonium oxidizing bacteria and anammox bacteria, in some embodiments of the present invention, a heterotropic denitrification process is integrated with nitritation and the anammox process. A two stage SBBR system can be configured in a number of ways and utilized to carry out the processes discussed herein. FIG. 1 is a schematic illustration of an integrated fixed film activated sludge (IFAS) process which includes two IFAS reactors operated in series and in a sequence batch reactor (SBR) mode. Reactors of the IFAS system are provided with aerators and at least some means to mix the contents of the reactors. In an integrated fixed film activated sludge system there is suspended biomass, as well as fixed film biomass in the reactors. That is, the reactor is provided with biofilm carriers to which certain bacteria attach and are supported thereby. The IFAS reactors, shown in FIG. 1, include settling and decanting phases in their operating cycle. This results in the retention of suspended-growth biomass in the reactors and it also results in the reactors producing a clarified effluent. Solids retention time (SRT) of the suspended-growth biomass in each of the IFAS reactors is controlled by controlling the discharge of waste activated sludge (WAS).

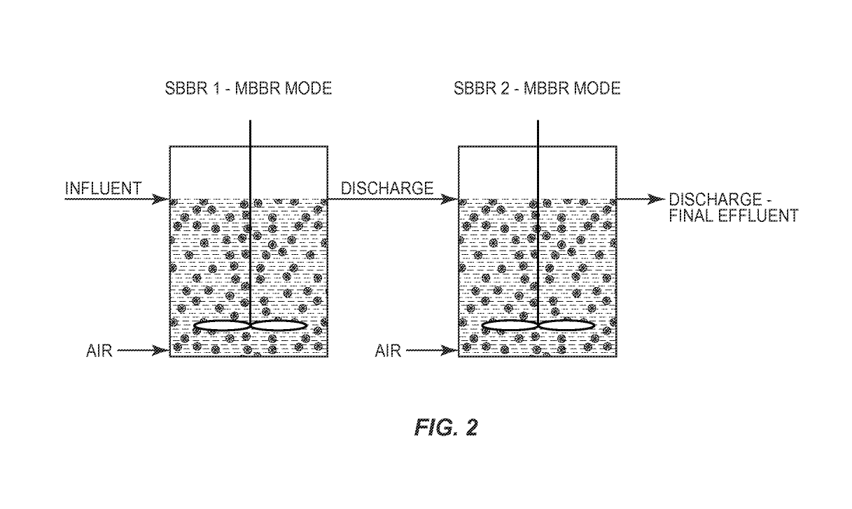

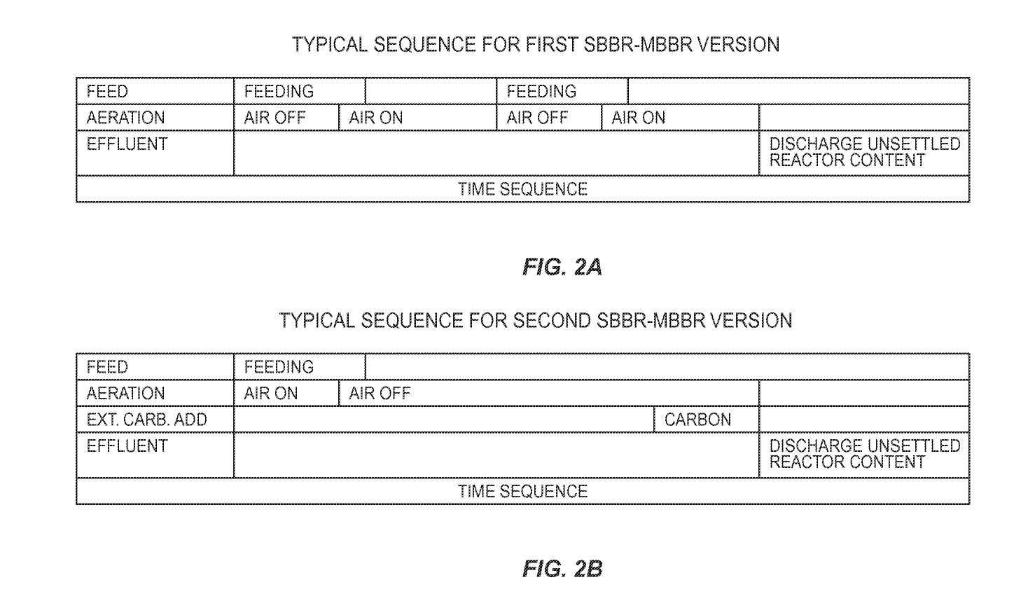

The two stage SBBR system disclosed herein can also be configured as moving bed biofilm reactors (MBBR). Such a system is schematically shown in FIG. 2. Here the system and process relies on biofilm carriers to support the biomass. As illustrated in FIG. 2, the two MBBRs are operated in the SBR mode but do not include settling and decanting phases in their operating cycle as is the case with the IFAS reactors of FIG. 1. Viewing FIG. 2, the reactor contents of the first SBBR is fed to the second SBBR without a clarification step. Sludge retention time in each reactor is equal to the reactor's hydraulic retention time (HRT). Like the IFAS reactors of FIG. 1, the reactors of the MBBR system of FIG. 2 include aerators and mixers for mixing the contents of the reactors.

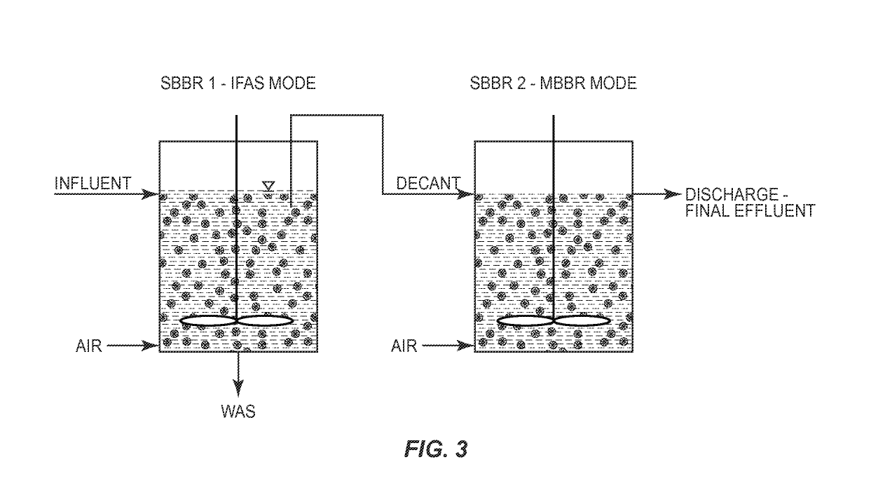

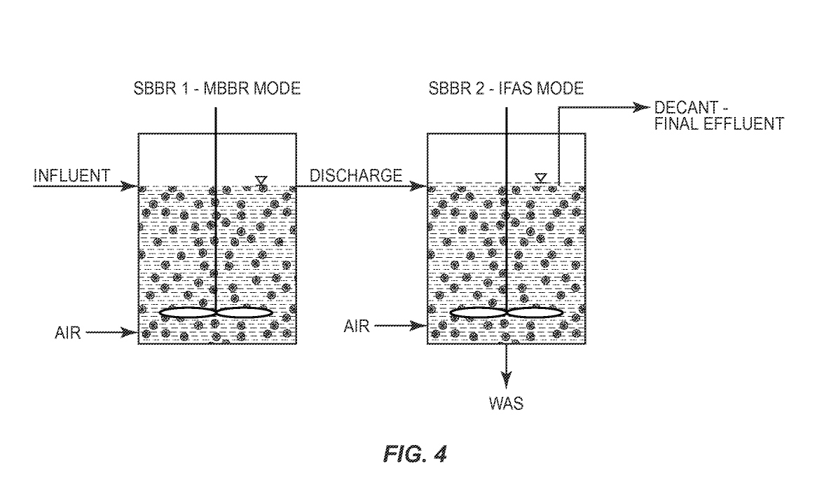

Furthermore, IFAS and MBBR systems can be integrated. In FIG. 3, there is shown a system where the first SBBR is an IFAS reactor and the second, or downstream reactor, is an MBBR reactor. In FIG. 4, the first SBBR reactor is an MBBR reactor and the second SBBR reactor is an IFAS reactor.

The system and process of the present invention is particularly suited for wastewater having some BOD but including a relatively low carbon-to-nitrogen ratio. The term “relatively low carbon-to-nitrogen ratio” means a BOD to TKN (total concentration of organic nitrogen and ammonia) ratio of 4 or less. In some embodiments, the first SBBR utilizes BOD in the wastewater to carry out a pre-denitrification process utilizing heterotropic bacteria. Pre-denitrification will significantly reduce the concentration of nitrite in the wastewater and will, to a lesser degree, reduce the concentration of nitrate in the wastewater. This pre-denitrification will be carried out under anoxic conditions in the first SBBR for a selected time period. Thereafter, the first SBBR will employ oxic conditions which result in a partial deammonification process, sometimes referred to as nitritation, using AOB to convert some of the existing ammonium in the wastewater to nitrite. There may be one or multiple anoxic-oxic phases carried out in the first SBBR. In some embodiments, the process envisions providing multiple intermittent aeration cycles in the first SBBR. This will repress the growth of aerobic nitrite oxidizers. The objective of the first SBBR is to produce an effluent that includes ammonium and nitrite that can be efficiently removed through the anammox process that forms the second part of the deammonification process. To achieve this, the process aims for the effluent from the first SBBR to include a nitrite-to-ammonium ratio at a target stoichiometric ratio range of 1.1 to 1.5. As stated above, ideally the nitrite-to-ammonium ratio should be approximately 1.3.

FIG. 1A shows a typical sequence for the first SBBR in an IFAS version. Note that there are two feeding periods and that the two feeding periods slightly overlap periods of “air off” and “air on”. With the air off, anoxic conditions in the first SBBR are maintained. With the air on, oxic conditions are maintained. In this example, there are two anoxic phases and two oxic phases. This could vary depending upon the wastewater being treated and other conditions. After the second oxic phase, there is a settling phase which is followed by a decanting phase and during decanting waste activated sludge is removed from the first SBBR.

TABLE 1
TABLE 1 - Typical phases and performance in SBBR 1 - IFAS Reactor (Q_{Feed} = 4 MGD, Reactor Vol. =
0.5 Mi. Gal, Flow Treated Per day, Q_{INF} = 1 MGD; SRT = 2 days; wastewater temp = 20° C., HRT = 12 hours).

| | Phase | | % of | | | | | | | Notes |
|---|---|---|---|---|---|---|---|---|---|---|
| | Length | DO | Tank Full | Typical Concentrations (mg/L) | | | | | | *TIN = NH₄—N + |
| Phase Name | Min | mg/L | % | MLSS | sBOD₅ | NH₄—N | NO₃—N | NO₂—N | TIN* | NO₃—N + NO₂—N |
| Feed | 30 | 0 | NA | NA | 100 | 60 | 0 | 0 | 60 | First Feed |
| Substrates Available | 30 | 0 | 83.3% | 1800 | 20* | 25.6* | 0.8* | 13.6* | 40* | *Available concentration |
| to Air Off Period | | | | | | | | | | after feed assuming no |
| after feed | | | | | | | | | | reaction only dilution |
| End of Air Off | | | | | 0 | 25.6 | 0 | 9.4 | 35 | Pre-denitrification - |
| | | | | | | | | | | 5 mg/L NOx—N is |
| | | | | | | | | | | denitrified witn 20 |
| | | | | | | | | | | mg/L of sBOD. |
| End of Air On | 60 | <0.5 | 83.3% | 1800 | 0 | 17 | 1 | 17 | 35 | Partial Nitrification |
| | | | | | | | | | | mainly to nitrite |
| Feed | 30 | 0 | NA | NA | 100 | 60 | 0 | 0 | 60 | Second Feed |
| Substrates Available | 30 | 0 | 100% | 1500 | 16.7* | 24.2* | 0.83* | 14.2* | 39.2* | *Available concentration |
| to Air Off Period | | | | | | | | | | after feed assuming no |
| after feed | | | | | | | | | | reaction only dilution |
| End of Air Off | | | | | 0 | 24.2 | 0 | 10.8 | 35 | Pre-denitrification - |
| | | | | | | | | | | 4.2 mg/L NOx—N is |
| | | | | | | | | | | denitrified with 16.7 |
| | | | | | | | | | | mg/L of sBOD. |
| End of Air On | 60 | <0.5 | 100% | 1500 | 0 | 17 | 1 | 17 | 35 | Partial Nitrification |
| | | | | | | | | | | mainly to nitrite |
| End of Settling | 30 | 0 | 100% | 2250 | 0 | 17 | 1 | 17 | 35 | |
| End of Decanting | 30 | 0 | 66.7% | 2250 | 0 | 17 | 1 | 17 | 35 | |
| Total Cycle | 240 | | | | | | | | | |

Table 1 appearing above shows typical phases and performance for the first SBBR when utilized in an IFAS version. Note that in this example the feed is assumed to be 4 MGD, reactor volume is 0.5 million gallons, flow treated per day, Q_{INF}=1 MGD, SRT is two days, the wastewater temperature is 20° C. and the influent hydraulic retention time is 12 hours. In this example, note that in the first anoxic phase that pre-denitrification removed 5 mg/L of NO_{X}—N with 20 mg/L of sBOD. This did not impact the ammonium concentration of 25.6 mg/L. It effectively reduced the nitrite (NO₂—N) by 4.2 mg/L and the nitrate (NO₃—N) by 0.8 mg/L. Note that during the anoxic first phase that the dissolved oxygen (DO) concentration was 0 mg/L. This first anoxic phase is followed by an oxic phase of 60 minutes. Even though this was an oxic phase, the dissolved oxygen concentration was maintained relatively low, at less than 1.0 mg/L and preferably less than 0.5 mg/L. During this oxic phase, partial nitritation occurred. AOB is used to convert portions of the ammonium (NH₄—N) to nitrite (NO₂—N). Note that during this oxic phase, the ammonium concentration was reduced from 25.6 mg/L to 17 mg/L and that the converted ammonium resulted in a slight increase of nitrate and a significant increase of nitrite to 17 mg/L.

Similar results are shown for the second anoxic and oxic phases for the first SBBR. Note that the final effluent produced by the first SBBR includes 17 mg/L of ammonium, 17 mg/L of nitrite and 1 mg/L of nitrate. Thus, the ratio of the nitrite to ammonium in the effluent is 1.1, which is within an acceptable stoichiometric ratio range for the efficient removal of ammonium and nitrite in the second SBBR via the anammox process. Also note that the soluble BOD in the wastewater has been removed and that after decanting, the first SBBR is ⅔ full.

It is desirable to utilize multiple mechanisms in the first SBBR to select the appropriate bacteria for the process. Dissolved oxygen concentration should be controlled. During the anoxic phases, the objective is to maintain dissolved oxygen concentration at 0 mg/L or near 0 mg/L. During the oxic phase, dissolved oxygen concentration should be maintained relatively low. In the first SBBR, the dissolved oxygen should be high enough to support nitritation but low enough to suppress NOB growth. In the examples illustrated herein and in a preferred embodiment, the dissolved oxygen concentration during oxic phases is maintained at 0.5 mg/L or less. When an IFAS system is used, it is desirable to maintain a relatively short SRT. In systems utilizing suspended growth, such as with an IFAS system, the aerobic SRT should be long enough to support AOB growth and short enough to wash out nitrite oxidizing bacteria. In one example, the SRT of the first SBBR is maintained at two days or less. Suspended biomass will help switch between oxic to anoxic conditions quickly by consuming oxygen with available influent BOD. The quick and frequent transition between oxic to anoxic phases in batch operation will help select AOB as well.

The effluent from the first SBBR is directed to the second SBBR and the objective is to reduce to relatively low levels the ammonium, nitrite and nitrate concentrations in the effluent. With reference to FIG. 1B, a typical sequence for the second SBBR in an IFAS version is shown. As seen therein, during the initial feeding period, the system is operated in an “air on” phase or mode. In this embodiment, prior to the feeding being complete, the air is shut off. During the last portion of the “air off” period, in this particular embodiment, carbon can be added. When the process calls for carbon to be added, carbon is gradually added over a time period. Thereafter, there is a settling phase, a decanting phase, and a period where waste activated sludge is removed from the second SBBR.

It is sometimes difficult to achieve low levels of nitrogen species by relying solely on the anammox process. This is because it is sometimes difficult to produce an effluent from the first SBBR that includes a nitrite-to-ammonium stoichiometric ratio that is within the targeted range. Furthermore, the anammox process itself produces some nitrate. That is, approximately 11% of the ammonium present in an anammox process ends up in the form of nitrate. Thus, it is desirable for the second SBBR to perform additional processes in conjunction with the anammox process in order to achieve relatively low levels of ammonium, nitrite and nitrate. Thus, the process of the present invention entails a second SBBR that is capable of performing additional processes. First, the second SBBR is provided with aeration and mixing capabilities. There are cases when the nitrite-to-ammonium ratio in the feed to the second SBBR is less than the targeted ratio range. In this case, operating at a low DO or in an oxic phase will convert, through nitritation, some ammonium to nitrite. Oxic conditions can be employed until the stoichiometric ratio of nitrite-to-ammonium is within the target range which, in a preferred embodiment, is a range of 1.1 to 1.5. If the ratio of nitrite-to-ammonium is greater than the targeted range, then in a final anoxic phase external carbon is added to remove the excess nitrite and nitrate produced by anammox process to meet the final effluent requirements. Adding extra carbon in an anoxic environment results in heterotropic denitrifying bacteria reducing the concentration of both nitrite and nitrate.

TABLE 2
Table 2 - Typical phases and performance in SBBR 2 - IFAS Reactor (Q_{Feed} = 8 MGD, Reactor Vol. =
0.5 Mi. Gal, Flow Treated Per day, Q_{INF} = 2.0 MGD; SRT = 4 days; wastewater temp = 20° C., HRT = 6.0 hours).

| | Phase | | % of | | | | | | | Notes |
|---|---|---|---|---|---|---|---|---|---|---|
| | Length | DO | Tank Full | Typical Concentrations (mg/L) | | | | | | *TIN = NH₄—N + |
| Phase Name | Min | mg/L | % | MLSS | sbOD₅ | NH₄—N | NO₃—N | NO₂—N | TIN* | NO₃—N + NO₂—N |
| Feed | 30 | 0 | NA | NA | 0 | 17 | 1.0 | 17 | 35 | From SBBR 1 |
| Substrates Available | 15 | <0.3 | 100% | 1500 | 0 | 6.3* | 1.0* | 6.3* | 13.6 | *Available concentration |
| to Air on Period | | | | | | | | | | after feed assuming no |
| after Feed | | | | | | | | | | reaction only dilution |
| End of Air On | | | | | 0 | 5.4 | 1.0 | 7.2 | 13.6 | Fine adjustment for |
| | | | | | | | | | | nitrite to ammonia ratio |
| End of Air Off | 45 | 0 | 100% | 1500 | 0 | 1.0 | 2.4 | 1.0 | 4.4 | Main phase - Anammox |
| | | | | | | | | | | Process |
| Available Carbon | | | 100% | 1500 | 5.6* | 0 | 0 | 0 | 0 | *5.6 mg/L BOD from |
| | | | | | | | | | | external carbon addition |
| End of Carbon | 15 | 0 | 100% | 1500 | 0 | 1.0 | 1.0 | 1.0 | 3.0 | Post DN with external |
| Addition | | | | | | | | | | carbon |
| End of Settling | 30 | 0 | 100% | 2250 | 0 | 1.0 | 1.0 | 1.0 | 3.0 | |
| End of Decanting | 15 | 0 | 66.7% | 2250 | 0 | 1.0 | 1.0 | 1.0 | 3.0 | |
| Total Cycle | 120 | | | | | | | | | |

Table 2 shows exemplary data that one would expect from the operation of the second SBBR in the IFAS mode. When feeding wastewater into the second SBBR, the freshly fed wastewater will be diluted by existing mixed liquor wastewater or biomass already in the second SBBR. Therefore, in the case of the example of Table 2, after the wastewater has been fed into the second SBBR, the ammonium concentration is 6.3 mg/L, the nitrite concentration is 6.3 mg/L and the nitrate concentration is 1.0 mg/L. Then, in the first or initial oxic phase with respect to this new feeding, the nitritation process converts part of the ammonium to nitrite and these result in an ammonium concentration of 5.4 mg/L and a nitrite concentration of 7.2 mg/L. Then the anammox process follows under anoxic conditions and it is seen where the ammonium concentration is reduced from 5.4 mg/L to 1.0 mg/L and the nitrite concentration is reduced from 7.2 mg/L to 1.0 mg/L. Because the anammox process produces nitrate, it is seen that the nitrate concentration increases from 1.0 to 2.4 mg/L. Because of the presence of nitrate in this example, at the end of the anammox process, external carbon is added. In this case, 5.6 mg/L of sBOD₅ was added. Once the external carbon is added, heterotrophic denitrifiers act under anoxic conditions to reduce the nitrate concentration from 2.4 mg/L to 1.0 mg/L. Thus, it is seen that in the second SBBR, the first oxic phase is utilized to bring the nitrite-to-ammonium stoichiometric ratio within the targeted range and the external carbon is added to be used in a post-denitrification process, again using heterotrophic denitrifiers, to, in this case, reduce the concentration of nitrate.

FIG. 1 in the above discussion deals with a two stage SBBR in an IFAS version. FIG. 2 discloses a two stage SBBR in an MBBR version. While there are some differences in the processes, the principal processes described with respect to the IFAS versions apply to the MBBR version. That is, the MBBR version is applicable to wastewaters having a relatively low carbon-to-nitrogen ratio and the overall process entails integrating heterotrophic denitrification with partial nitritation and the anammox process. As noted above, there are some differences between the processes of FIGS. 1 and 2. The MBBR process does not waste sludge from either of the two SBBRs.

FIGS. 2A and 2B show a typical sequence for the first and second SBBRs of the process depicted in FIG. 2. Note that in the first SBBR, there are two feeding periods and each feeding period extends over an “air off” period and slightly overlaps an “air on” period. As discussed with the IFAS version above, during the “air off” periods, the first SBBR is operated under anoxic conditions, which means that there is no supplied air and the DO concentration in the wastewater is zero or near zero. Under these anoxic conditions, some heterotrophic denitrification can occur and, as discussed above, this has the effect of removing BOD and reducing nitrite concentration and, to some degree, nitrate concentration. During periods of “air on”, the first SBBR is operated under oxic conditions but still with a relatively low DO concentration on the order of 0.5 mg/L or less. This enables nitritation to occur which, as discussed above, results in nitrite accumulation as portions of the ammonium in the wastewater are converted to nitrite.

TABLE 3
Table 3 - Typical phases and performance in SBBR 1 - MBBR Reactor (Q_{Feed} = 4 MGD, Reactor Vol. =
0.5 Mi. Gal, Flow Treated Per day, Q_{INF} = 1 MGD; SRT = HRT = 12 hours, wastewater temp = 20° C.).

| | Phase | | % of | | | | | | | Notes |
|---|---|---|---|---|---|---|---|---|---|---|
| | Length | DO | Tank Full | Typical Concentrations (mg/L) | | | | | | *TIN = NH₄—N + |
| Phase Name | Min | mg/L | % | TSS | sBOD₅ | NH₄—N | NO₃—N | NO₂—N | TIN* | NO₃—N + NO₂—N |
| Feed | 30 | 0 | NA | 100 | 100 | 60 | 0 | 0 | 60 | First Feed |
| Substrates Available | 45 | 0 | 83.3% | 120 | 20* | 25.6* | 0.8* | 13.6* | 40* | *Available concentration |
| to Air Off Period | | | | | | | | | | after feed assuming no |
| after feed | | | | | | | | | | reaction only dilution |
| End of Air Off | | | | | 0 | 25.6 | 0 | 9.4 | 35 | Pre-denitrification - |
| | | | | | | | | | | 5 mg/L NOx—N is |
| | | | | | | | | | | denitrified with 20 |
| | | | | | | | | | | mg/L of sBOD. |
| End of Air On | 75 | <0.5 | 83.3% | 102 | 0 | 17 | 1 | 17 | 35 | Partial Nitrification |
| | | | | | | | | | | mainly to nitrite |
| Feed | 30 | 0 | NA | 100 | 100 | 60 | 0 | 0 | 60 | Second Feed |
| Substrates Available | 45 | 0 | 100% | 120 | 16.7* | 24.2* | 0.83* | 14.2* | 39.2* | *Available concentration |
| to Air Off Period | | | | | | | | | | after feed assuming no |
| after feed | | | | | | | | | | reaction only dilution |
| End of Air Off | | | | | 0 | 24.2 | 0 | 10.8 | 35 | Pre-denitrification - |
| | | | | | | | | | | 4.2 mg/L NOx—N is |
| | | | | | | | | | | denitrified with 16.7 |
| | | | | | | | | | | mg/L of sBOD. |
| End of Air On | 75 | <0.5 | 100% | 120 | 0 | 17 | 1 | 17 | 35 | Partial Nitrification |
| | | | | | | | | | | mainly to nitrite |
| Total Cycle | 240 | | | | | | | | | |

Table 3 is exemplary data and shows typical phases and performances of the first SBBR in the MBBR version of FIG. 2. The basic process variables discussed above with respect to Table 1 are the same. Again, it is seen that in the pre-denitrification phase of the first SBBR, 5 mg/L of nitrite and nitrate is denitrified with 20 mg/L of sBOD. This is followed by partial nitritation where 25.6 mg/L of ammonium is reduced to 17 mg/L of ammonium, and at the same time the nitrite concentration is increased from 9.4 mg/L to 17 mg/L. Similar results are obtained in the second anoxic-oxic phases where additional wastewater is fed into the first SBBR. As can be seen in Table 3, the effluent from the first SBBR includes no sBOD, 17 mg/L of ammonium, 1 mg/L of nitrate, and 17 mg/L of nitrite.

FIG. 2B shows a typical sequence for the second SBBR in the process shown in FIG. 2. In this case there is only one feeding phase. The feeding phase extends over a first “air on” period and slightly overlaps the initial portion of the succeeding “air-off” period. Again, at the end of the “air-off” period, external carbon may be added. Finally, there is the discharge of unsettled reactor contents.

The “air off” phase is used primarily to grow anammox bacteria and to carry out the anammox process where biomass on biofilm carriers contained in the second SBBR are effective to convert both ammonium and nitrite to elemental nitrogen. However, there may be cases where the nitrite-to-ammonium stoichiometric ratio is outside of the targeted range. As discussed above, various means can be employed to bring the nitrate-to-ammonium stoichiometric target ratio within the selected range of 1.1 to 1.5. If an initial “air on” phase or oxic phase is employed, then some of the ammonium will be converted to nitrite in the second SBBR. If the concentration of the nitrite is too high, with respect to the targeted nitrite-ammonium target ratio range, then by adding external carbon this will reduce the concentration of both the nitrite and the nitrate through a post-denitrification process. Thus, the oxic conditions employed, as well as the post-denitrification process, are mechanisms for fine-tuning the nitrite-to-ammonium ratio so as to enhance the efficiency of the anammox process.

TABLE 4
Table 4 - Typical phases and performance in SBBR 2 - MBBR Reactor (Q_{Feed} = 8 MGD, Reactor Vol. =
0.5 Mi. Gal, Flow Treated Per day, Q_{INF} = 2.0 MGD; SRT = HRT = 6.0 hours, wastewater temp = 20° C.).

| | Phase | | % of | | | | | | | Notes |
|---|---|---|---|---|---|---|---|---|---|---|
| | Length | DO | Tank Full | Typical Concentrations (mg/L) | | | | | | *TIN = NH₄—N + |
| Phase Name | Min | mg/L | % | TSS | sBOD₅ | NH₄—N | NO₃—N | NO₂—N | TIN* | NO₃—N + NO₂—N |
| Feed | 30 | 0 | NA | 100 | 0 | 17 | 1.0 | 17 | 35 | From SBBR 1 |
| Substrates Available | 30 | <0.3 | 100% | 120 | 0 | 6.3* | 1.0* | 6.3* | 13.6 | *Available concentration |
| to Air on Period | | | | | | | | | | after feed assuming no |
| after Feed | | | | | | | | | | reaction only dilution |
| End of Air On | | | | | 0 | 5.4 | 1.0 | 7.2 | 13.6 | Fine adjustment for |
| | | | | | | | | | | nitrite to ammonia ratio |
| End of Air Off | 75 | 0 | 100% | 120 | 0 | 1.0 | 2.4 | 1.0 | 4.4 | Main phase - Anammox |
| | | | | | | | | | | Process |
| Available Carbon | | | 100% | 120 | 5.6* | 0 | 0 | 0 | 0 | *5.6 mg/L BOD from |
| | | | | | | | | | | external carbon addition |
| End of Carbon | 15 | 0 | 100% | 120 | 0 | 1.0 | 1.0 | 1.0 | 3.0 | Post DN with external |
| Addition | | | | | | | | | | carbon |
| Total Cycle | 120 | | | | | | | | | |

Table 4 is exemplary data showing the typical phases and performance of the second SBBR in FIG. 2. Note that the feed includes 17 mg/L of ammonium, 1.0 mg/L of nitrate, and 17 mg/L of nitrite. Note that at the end of the “air on” phase, that with fine adjustment for nitrite-to-ammonium ratio, the ammonium concentration has been reduced to 5.4 mg/L and the nitrite concentration is 7.2 mg/L. At the end of the “air off” phase, the anammox process has reduced the ammonium concentration to 1.0 mg/L and the nitrite concentration to 1.0 mg/L. But because the anammox process tends to increase the nitrate concentration, the nitrate concentration has been increased from 1 mg/L to 2.4 mg/L. In order to address the nitrate concentration, in some embodiments, a post-denitrification process using heterotrophic denitrifiers is employed. To accomplish this, during a portion of the “air off” phase, external carbon is added which, as Table 4 shows in one example, 5.6 mg/L of sBOD₅ is added to the wastewater in the second SBBR. This, in the example illustrated in Table 4, reduces the nitrate from 2.4 mg/L to 1.0 mg/L.

The processes shown in FIGS. 3 and 4 are hybrid processes of those shown in FIGS. 1 and 2 and discussed above. In the case of FIG. 3, the process entails a first SBBR that is operated in the IFAS version and a second SBBR that is operated in the MBBR version. The FIG. 4 process is the opposite of that shown in FIG. 3 as the first SBBR is operated in an MBBR version and the second SBBR is operated in an IFAS version. The basic process principles discussed above are carried out essentially the same manner as discussed above. That is, in the first SBBR, there can be multiple anoxic-oxic phases and multiple feedings and pre-nitrification can be incorporated with a process of partial nitritation. Likewise, in the second SBBR, in addition to the basic anoxic process, there can be an initial oxic phase where extra ammonium is converted to nitrite in order to bring the nitrite-to-ammonium concentration within a targeted ratio range. In addition, at the end of the anoxic period, external carbon can be added to reduce the concentration of nitrite and nitrate.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

What is claimed is:

1. A method of removing ammonium from wastewater in a mainstream anammox process comprising:
a. directing the wastewater to a first sequence biofilm batch reactor (SBBR);
b. treating the wastewater in the first SBBR and accumulating nitrite in the wastewater such that the wastewater includes nitrite and ammonium at a target stoichiometric ratio that enables anammox bacteria to effectively remove ammonium and nitrite from the wastewater;
c. decanting the wastewater having the ammonium and nitrite from the first SBBR and directing the wastewater to a second SBBR; and
d. operating the second SBBR under anoxic or oxic conditions and employing anammox biomass to remove ammonium and nitrite from the wastewater.

2. The method of claim 1 wherein the wastewater includes a relatively low carbon-to-nitrogen ratio and the method includes denitrifying the wastewater in the first SBBR and removing substantially all BOD from the wastewater in the first SBBR.

3. The method of claim 1 including, over a selected period of time, maintaining the dissolved oxygen concentration in the wastewater in the first SBBR at 1.0 mg/L or lower.

4. The method of claim 1 wherein the stoichiometric ratio of nitrite to ammonium in the wastewater fed to the second SBBR is generally in the range of 1.1 to 1.5.

5. The method of claim 1 wherein the wastewater includes a relatively low carbon-to-nitrogen ratio and the method entails operating the first SBBR in anoxic and oxic phases wherein in the anoxic phase the wastewater is subjected to a pre-nitrification process where heterotrophic bacteria removes BOD contained in the wastewater; and wherein the oxic phase follows the anoxic phase and in the oxic phase a nitritation process is carried out where portions of ammonium in the wastewater is converted to nitrite.

6. The method of claim 5 wherein, in the second SBBR, an oxic phase is included to convert another portion of the ammonium to nitrite.

7. The method of claim 1 wherein aerobic ammonium oxidizing bacteria in the first SBBR perform nitritation and wherein the anammox biomass in the second SBBR performs an anaerobic ammonium oxidation process that removes nitrite and ammonium from the wastewater.

8. The method of claim 1 wherein there is provided an oxic phase in the second SBBR where the ammonium concentration in the wastewater is reduced by converting a portion of the ammonium to nitrite such that the stoichiometric ratio of nitrite-to-ammonium is within the range of 1.1 to 1.5.

9. The method of claim 8 wherein, during the anoxic phase in the second SBBR, an external source of carbon is added to the wastewater and the concentration of nitrate in the wastewater is reduced through denitrification in the second SBBR.

10. The method of claim 1 further including:
removing BOD from the wastewater by pre-denitrifying the wastewater in the first SBBR by operating the first SBBR under anoxic conditions;
after removing the BOD from the wastewater, subjecting the wastewater to oxic conditions and employing a nitritation process to convert some of the ammonium in the wastewater to nitrite;
in the second SBBR, adjusting the nitrite-to-ammonium ratio by subjecting the wastewater to oxic conditions and converting some of the ammonium in the wastewater in the second SBBR to nitrite;
after adjusting the ratio of nitrite to ammonium in the second SBBR, employing anoxic conditions in the second SBBR and reducing the concentration of ammonium and nitrite through the anammox process; and
adding external carbon to the second SBBR and reducing the concentration of nitrate in the wastewater in the second SBBR through a denitrification process.

11. The method of claim 1 including repressing the growth of aerobic nitrite oxidizers in the first SBBR by providing multiple aeration cycles in the first SBBR.

12. The method of claim 1 including operating the first SBBR in multiple anoxic-oxic sequences and pre-denitrifiying the wastewater during the anoxic sequences and utilizing AOB to partially convert ammonium to nitrite during the oxic sequences.

13. A method of removing BOD and ammonium from wastewater having a relatively low carbon-to-nitrogen ratio by utilizing a two-stage sequence batch biofilm reactor (SBBR), the method comprising:
a. directing the wastewater into a first SBBR having biofilm carriers therein and subjecting the wastewater to both anoxic and oxic phases within the first SBBR;
b. during the anoxic phase in the first SBBR removing BOD from the wastewater with heterotrophic bacteria and in the process partially denitrifying the wastewater;
c. during the oxic phase in the first SBBR utilizing AOB to perform nitritation and to convert a portion of the ammonium in the wastewater to nitrite;
d. after treating the wastewater in the first SBBR reactor, directing the wastewater to a second SBBR reactor having biofilm carriers therein; and
e. operating the second SBBR reactor under anoxic conditions for a selected period of time and utilizing anammox bacteria to reduce the ammonium and nitrite concentration of the wastewater.

14. The method of claim 13 including operating the second SBBR reactor during a selected period of time so as to maintain a nitrite-to-ammonium ratio within a selected target range.

15. The method of claim 13 wherein there is a target nitrite-to-ammonium stoichiometric ratio range for the wastewater in the second SBBR reactor; and wherein if the nitrite-to-ammonium ratio in the wastewater in the second SBBR reactor is less than the target range, then conditions are employed in the SBBR reactor to increase the nitrite concentration in the wastewater; and wherein if the nitrite-ammonium ratio is higher than the target range, then conditions are employed in the SBBR reactor to decrease the nitrite concentration in the wastewater.

16. The method of claim 13 wherein the first SBBR is operated in an IFAS or MBBR mode and wherein the second SBBR is operated in the IFAS or MBBR mode.

17. The method of claims 13 wherein the second SBBR is also operated under oxic conditions for a selected time period to convert some ammonium to nitrite through a nitritation process; and wherein the wastewater in the second SBBR is also subjected to a post-denitrification process under anoxic conditions that reduces the concentration on nitrate in the wastewater.

18. The method of claim 17 wherein in the second SBBR the oxic phase precedes the anoxic phase and the processes carried out in the second SBBR generally include conversion of some ammonium to nitrite, followed by the anammox process and the reduction of ammonium and nitrite concentration and, finally, post-denitification where the nitrate concentration in the wastewater.

19. The method of claim 13 including providing multiple aeration cycles in the first SBBR.

20. The method of claim 19 including repressing the growth of aerobic nitrite oxidizers in the first SBBR by providing multiple aeration cycles in the first SBBR.

21. The method of claim 13 including operating the first SBBR in multiple anoxic-oxic sequences and pre-denitrifying the wastewater in the first SBBR during the anoxic sequences and utilizing AOB to partially convert ammonium to nitrite during the oxic sequences.

22. A method of removing BOD and ammonium from wastewater having a relatively low carbon-to-nitrogen ratio by utilizing a two stage sequence batch biofilm reactor (SBBR), the method comprising:
a. directing the wastewater into a first SBBR having biofilm carriers therein and subjecting the wastewater to both anoxic and oxic phases within the first SBBR;
b. removing BOD from the wastewater in the first SBBR through a pre-denitification process carried out under the anoxic phase;
c. after pre-denitrifying the wastewater, converting a portion of ammonium in the wastewater to nitrite through a nitritation process carried out in the oxic phase in the first SBBR;
d. after pre-denitrifying the wastewater and subjecting the wastewater to nitritation, directing the wastewater from the first SBBR to a second SBBR having biofilm carriers therein;
e. in the second SBBR:
i. subjecting the wastewater to oxic conditions and converting some ammonium to nitrite;
ii. after converting some ammonium to nitrite in the second SBBR, reducing the concentration of ammonium and nitrite by employing an anammox process under anoxic conditions; and
iii. after the initiation of the anammox process, supplying an external carbon source to the wastewater in the second SBBR and conducting a post-denitrification process in the second SBBR where the concentration of nitrate in the wastewater is reduced.

23. The method of claim 22 including providing multiple aeration cycles in the first SBBR.

24. The method of claim 23 including repressing the growth of aerobic nitrite oxidizers in the first SBBR by providing multiple aeration cycles in the first SBBR.

25. The method of claim 22 including operating the first SBBR in multiple anoxic-oxic sequences and pre-nitrifying the wastewater in the first SBBR during the anoxic sequences and utilizing AOB to partially convert ammonium to nitrite during the oxic sequences.
